(19) United States
(12) Patent Application Publication
(10) Pub. No.: US 2025/0148623 A1
(43) Pub. Date: May 8, 2025

(54) HUMAN MOTION UNDERSTANDING USING STATE SPACE MODELS

(71) Applicant: Apple Inc., Cupertino, CA (US)

(72) Inventors: Arnab Kumar Mondal, Cupertino, CA (US); Stefano Alletto, Mountain View, CA (US); Denis Tome', Sunnyvale, CA (US); Abhishek Narain, San Ramon, CA (US)

(21) Appl. No.: 18/921,174

(22) Filed: Oct. 21, 2024

Related U.S. Application Data
(60) Provisional application No. 63/647,839, filed on May 15, 2024.
(60) Provisional application No. 63/547,202, filed on Nov. 3, 2023.

(51) Int. Cl. G06T 7/246; G06T 17/20

(52) U.S. Cl. CPC G06T 7/251; G06T 17/20; G06T 2207/10016; G06T 2207/20081; G06T 2207/30196

(57) ABSTRACT

Various implementations disclosed herein include devices, systems, and methods that generate 3-dimensional (3D) information related to a user from a continuous time light signal. For example, a process may obtain two-dimensional (2D) information corresponding to a continuous time light signal providing information about a user in a 3D environment. The 2D information may be based on frames comprising images capturing the continuous time light signal at one or more frame rates. The process may further obtain discretization information corresponding to the one or more frame rates. The process may further determine 3D information about the user by inputting the 2D information and the discretization information into a state space model. The state space model may be a continuous time learnable framework for mapping between continuous time 2D scalar inputs and continuous time scalar 3D outputs.

### CROSS-REFERENCE TO RELATED APPLICATIONS

This application claims the benefit of U.S. Provisional Application Ser. No. 63/647,839 filed May 15, 2024, and U.S. Provisional Application Ser. No. 63/547,202 filed Nov. 3, 2023, each of which is incorporated by reference herein in its entirety.

### TECHNICAL FIELD

The present disclosure generally relates to systems, methods, and devices that generate 3-dimensional (3D) information related to a user from a continuous time light signal.

### BACKGROUND

Existing techniques for evaluating human motion from a video stream for use with applications such as pose estimation, mesh recovery and action recognition may be improved with respect to adapting to new frame rates during real time processing of a continuous stream of video frames.

### SUMMARY

Various implementations disclosed herein include devices, systems, and methods that determine 3-dimensional (3D) information related to a user from a continuous time light signal. For example, a continuous time light signal may include a signal comprising a continuous light that is reflected from the user and is captured by an image sensor(s) at discrete times and frame rates.

Some implementations acquire input information such as 2-dimensional (2D) information associated with a continuous time light signal providing information about a user in a three-dimensional (3D) environment such as, inter alia, 2D joint positions within a sequence of frames of a video signal capturing a continuous time light signal with respect to one or more frame rates.

Some implementations acquire input information such as discretization information such as, inter alia, delta information corresponding to a time between frames, frame rate information, etc.

Some implementations enable a state space model to acquire input information to generate the 3D information. The 3D information may provide a 3D shape, model or mesh, 3D joints, a 3D location, an action performed, a number of times an action is performed, etc. The use of a state space model to generate the 3D information may be beneficial with respect to accuracy and efficiency in comparison to alternatively using transformers or long term-short term (LSTM) networks. The use of discretization information may enable adaptability without retraining with respect to different video frame rates.

In some implementations, an electronic device has a processor (e.g., one or more processors) that executes instructions stored in a non-transitory computer-readable medium to perform a method. The method performs one or more steps or processes. In some implementations, the electronic device obtains two-dimensional (2D) information corresponding to a continuous time light signal providing information about a user in a three-dimensional (3D) environment. The 2D information may be based on frames comprising images capturing the continuous time light signal at one or more frame rates. In some implementations, discretization information corresponding to the one or more frame rates is obtained and 3D information about the user may be determined by inputting the 2D information and the discretization information into a state space model. The state space model is a continuous time learnable framework for mapping between continuous time 2D scalar inputs and continuous time scalar 3D outputs.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIG. 2 illustrates an example representing a state space model (SSM) associated with generating 3D information related to a user, in accordance with some implementations.

FIG. 3 illustrates continuous-time attention-free architecture that obtains spatiotemporal human motion data as input and outputs representations corresponding to each spatial and temporal location, in accordance with some implementations.

FIG. 4 illustrates bidirectional GDSSM architecture, in accordance with some implementations.

FIG. 5 illustrates unidirectional GDSSM architecture, in accordance with some implementations.

FIG. 6 is a flowchart representation of an exemplary method that determines 3D information associated with a user from a continuous time signal captured by an image sensor at discrete times, in accordance with some implementations.

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

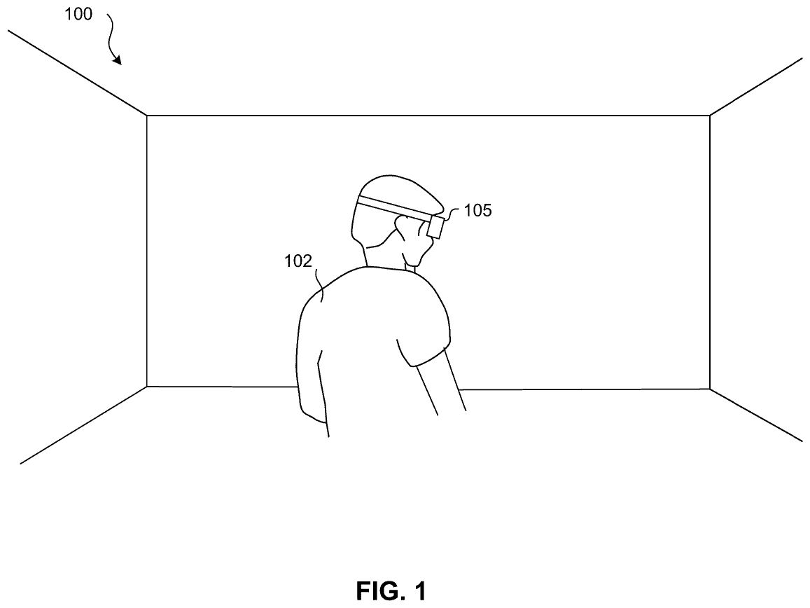

FIG. 1 illustrates an exemplary electronic device 105 operating in a physical environment 100. In the example of FIG. 1, the physical environment 100 is a room. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an HMD (e.g., device 105), communicatively coupled to a server, or other external device may be configured generate 3D information associated with a user based on analyzing a continuous time signal such as a signal comprising continuous light reflected from a user (e.g., user 102) that is captured by an image sensor at discrete times/frames.

In some implementations, 2D information, such as, inter alia, 2D joint locations of a user is obtained. The 2D information may correspond to a continuous time light signal providing information about the user in a 3D environment (e.g., an XR environment provided by electronic device 105). The 2D information may be based on frames that include images capturing the continuous time light signal at one or more frame rates.

In some implementations, discretization information corresponding to the one or more frame rates is obtained. The discretization information may include delta information corresponding to, inter alia, a time period occurring between frames (e.g., delta information), frame rate information, etc.

In some implementations, 3D information associated with the user may be determined by inputting the 2D information and the discretization information into a state space model. For example, a state space model may be a continuous time learnable framework for performing a mapping process between continuous time 2D scalar inputs and continuous time scalar 3D outputs. In some implementations, the 3D information may provide a 3D model representing a portion(s) of the user. In some implementations, the 3D information may provide a 3D representation of a joint(s) of the user at a specified location within a 3D environment. In some implementations, the 3D information may provide information associated with an action performed by the user. In some implementations, the 3D information may provide information associated with a number of times the action is performed by the user.

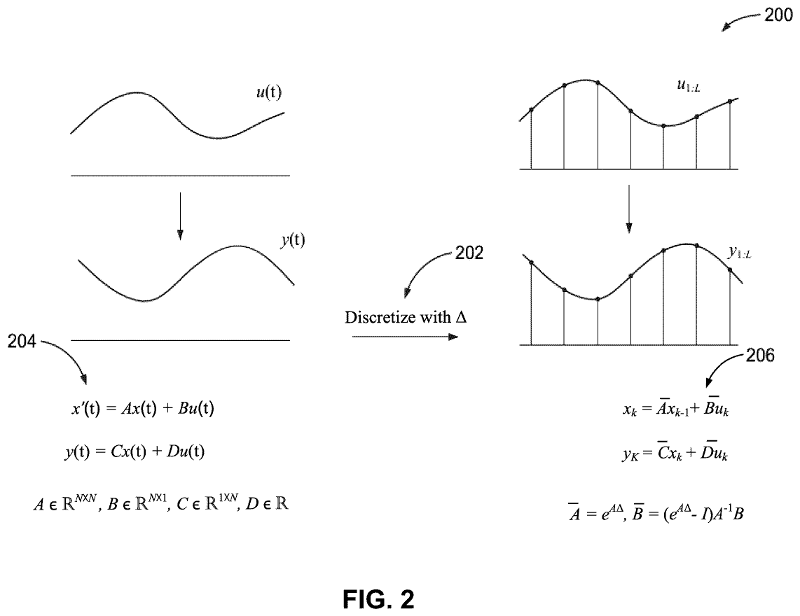

FIG. 2 illustrates an example representing a state space model (SSM) 200 associated with generating 3D information related to a user, in accordance with some implementations. SSM 200 provides a continuous time learnable framework providing mapping between continuous-time scalar 2D inputs and continuous-time scalar 3D outputs. For example, given an input u(t) and an output y(t), SSM 200 may be described by the following differential equations 204 involving a continuous-time state vector x(t) and its associated derivative x′(t), parameterized by matrices A∈ [symbol] ^{N×N}, B∈ [symbol] ^{N×1}, C∈ [symbol] ^{1×N} and D∈ [symbol] :

x′(t)=Ax(t)Bu(t),y(t)=Cx(t)Du(t).

In discrete-time, with a parameterized sample time Δ 202, differential equations 204 may transition into the following recursive formulations 206:

$${x}_{k} = \overline{A} {x}_{k - 1} + \overline{B} {u}_{k} , {y}_{k} = \overline{C} {x}_{k} \overline{D} {u}_{k} .$$

where Ã=e^{AΔ}, B̅=(e^{AΔ}−I) A⁻¹ B, C̅=C and D̅=D using zero order hold (zoh) discretization.

In some implementations, a linear nature of SSM 200 allows an output sequence to be computed directly by unrolling the recursion in time as follows:

$${y}_{k} = {\sum }_{j = 0}^{k} \overline{C} {\overline{A}}^{j} \overline{B} \cdot {u}_{k - j} .$$

An advantage of the above structure is the potential for parallel computation, facilitated by the discrete convolution of the input sequence u with the precomputed SSM kernel K=(C̅B, C̅ ĀB̅, . . . , C̅ Ā^{L-1} B̅), denoted as follows:

$$y = K * {}_{c} u$$

While the approach to the above computation requires O(L²) multiplications, it may be done in O(Z log(L)) time using a Fast Fourier Transform (FFT). SSM 200 may be configured to switch from a convolutional to recursive formulation in the aforementioned recursive formulations when properties such as autoregressive decoding is desirable.

In some implementations, an efficient adaptation of a framework of SSM 200 is the incorporation of a diagonal state matrix, facilitating the computation of SSM 200 kernel K. For example, a diagonal state matrix A represented as Λ=diag(λ₁, . . . , λ_{N}) may effectively approximate a hyper parameter optimization (HIPPO) parameterization of a transition matrix A that yields a stable training regime with long sequences. Further simplifications may be introduced with a vector B expressed as B=(1)_{N×1}. Under these conditions, a diagonal state space model (DSSM) may be characterized by learnable parameters: Λᵣₑ, Λᵢₘ ∈ [symbol] ^{N}, C∈ [symbol] ^{N}, and Δ_{log}∈ [symbol] . Subsequently, diagonal elements of A are computed through the relationship exp(Λᵣₑ)+i·Λᵢₘ, where i=\sqrt{−1} and Δ is deduced as exp(Δ_{log})∈ [symbol] ^{>0}. Kernel K may be computed as follows:

$$K = {( C ⊙ [ \begin{matrix}e λ 1 Δ & - & 1 / λ 1 \\ & ⋱ & \\ e λ N Δ & - & 1 / λ N\end{matrix} ] )}^{T} exp ( P ) \qquad ( 3 )$$

where ⊙ is element-wise multiplication and the elements of matrix P∈ [symbol] ^{N×L} are being given by Pⱼₖ=λⱼₖΔ. In practice, to obtain a real valued kernel K, the diagonal elements are assumed to appear in complex conjugate pairs and their corresponding parameters in C are tied together. Therefore, the dimension of state space is effectively set to N/2 and a final kernel is obtained by taking the real part of 2·K.

The aforementioned framework may establish a linear mapping for 1-D sequences and when extending to sequences comprising H-dimensional vectors, individual state space models may be applied to each of the H dimensions. Specifically, a DSSM layer takes a sequence of length L, denoted as u∈ [symbol] ^{H×L}, and yields an output y∈ [symbol] ^{H×1}. For each feature dimension h=1, . . . , H, a kernel Kₕ∈ [symbol] ^{L} is computed and a corresponding output y∈ [symbol] ^{L} for this feature is obtained using the convolution of input uₕ∈ [symbol] ^{L} and kernel Kₕ in accordance with y=K*_{c}u as described, supra. The aforementioned process may be performed for a batch of samples leading to a linear DSSM layer that may map from u∈ [symbol] ^{B×L×H} to y∈ [symbol] ^{B×L×LH} and is denoted by y=DSSM(u).

Considering a batch size of B, sequence length L, and hidden dimension H, a computation time for kernels in a diagonal state space (DSS) layer may scale as O(N H L), whereas a discrete convolution may demand a time complexity of O(B H L log(L)).

DSSM parameters may be initialized by using linear initialization setting the real part Λᵣₑ to

$$- \frac{1}{2} {N}_{}$$

and an imaginary part Λᵢₘ to

$$( π j ) \frac{N}{j = 1} = 1.$$

Likewise, elements of C may include samples from a normal distribution and Δ may be initialized randomly between 0.001 and 0.1.

In some implementations, differing types of neural architectures, including multi-layer perceptrons (MLPs), CNNs, and transformer models may benefit from integration of gating units such as a gated linear unit (GLU), which may be effective in CNN-based natural language processing (NLP) applications. For example, with respect to a given input activation, denoted as u, a GLU may perform two distinct operations such as calculating a gating vector σ(Wu) and a linear transformation Vu. A final output of the GLU may be obtained by computing the Hadamard product: σ(Wu)⊙Vu.

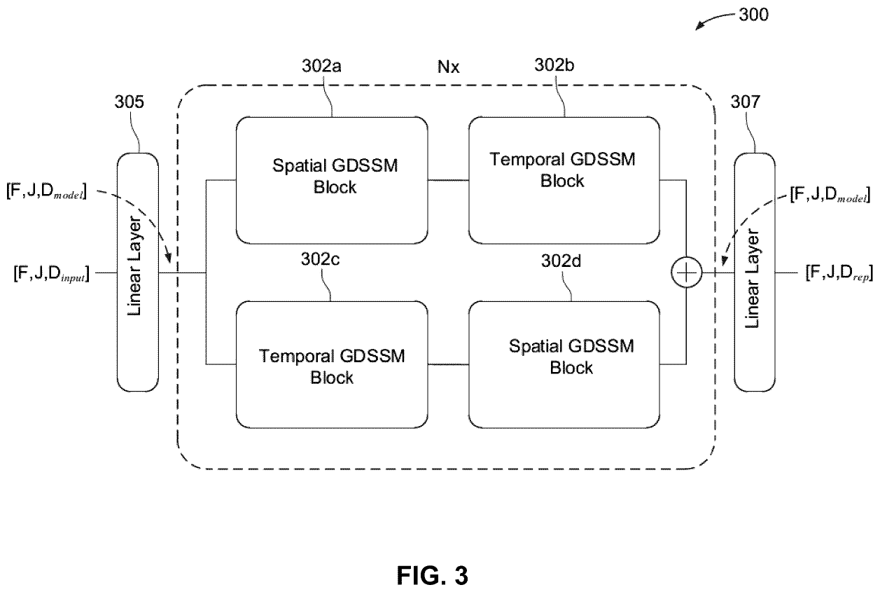

FIG. 3 illustrates continuous-time attention-free architecture 300 that obtains spatiotemporal human motion data as input and outputs representations corresponding to each spatial and temporal location, in accordance with some implementations. For example, an input to architecture 300 may include a video of key points u∈ [symbol] ^{B×F×J×D}ᵢₙ, where B is a batch size, F is a number of frames, J is a number of joints, and Dᵢₙ is a dimension of the input which is typically 3 for the 2D joint positions and scalar joint confidence. Architecture 300 is configured to learn to model an underlying continuous signal resulting from evolution of joint positions and associated interactions with each other to produce a spatiotemporal representation r∈ [symbol] ^{B×F×J×D}ᵣₑₚ. As illustrated in FIG. 3, architecture 300 includes a sequence of spatiotemporal blocks consisting of spatial and temporal gated diagonal state space model (GDSSM) blocks 302a, 302b, 302c, and 302d. Likewise, architecture 300 uses a lifting layer 305 to lift an input to a model dimension Dₘ and a final layer 307 to transform representations in model dimensions to required representation dimension Dᵣₑₚ.

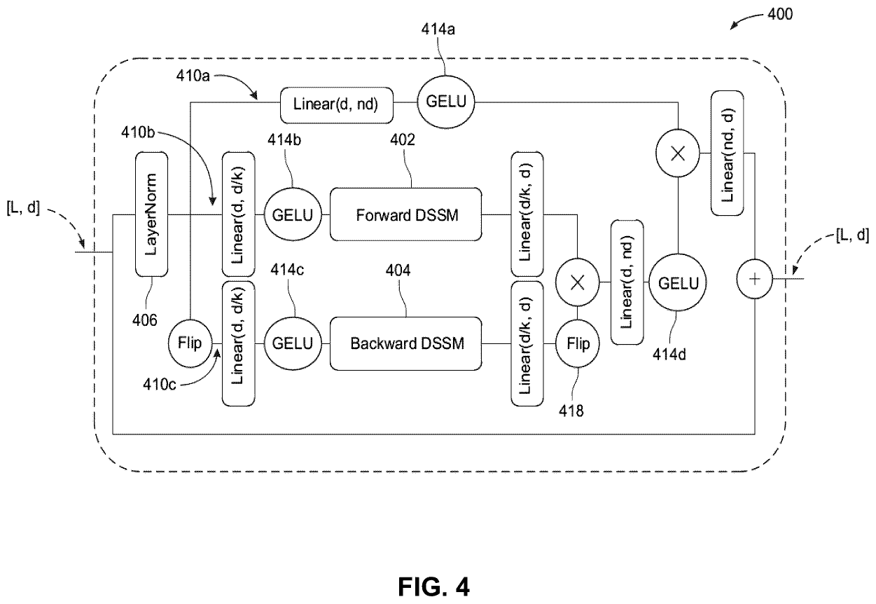

FIG. 4 illustrates bidirectional GDSSM architecture 400, in accordance with some implementations. Bidirectional GDSSM architecture 400 may receive as input: x∈ [symbol] ^{B×F×J×D}ₘ, such that bidirectional GDSSM blocks (forward DSSM block 402 and backward DSSM block 404) learn to combine information along a sequence dimension L. As illustrated in FIG. 4, architecture 400 comprises an initial layer norm 406 and includes three main pathways 410a, 410b, and 410c to process information. Pathway 410a is configured to processes information independently. Pathway 410b and pathway 410c are configured to processes information with respect to a combination of forward and backward paths within a sequence dimension as follows:

$$\begin{matrix}{x}_{N} = LayerNorm ( x ) & ∈ {ℝ}^{B \times L \times {D}_{m}} \\ {x}_{id} = σ ( {x}_{N} {W}_{id} ) & ∈ {ℝ}^{B \times L \times {nD}_{m}} \\ {x}_{f} = {DSSM}_{f} ( σ ( {x}_{N} W \frac{1}{f} ) ) W \frac{2}{f} & ∈ {ℝ}^{B \times L \times {D}_{m}} \\ {x}_{b} = flip ( {DSSM}_{b} ( σ ( flip ( {x}_{N} ) W \frac{1}{b} ) ) W \frac{1}{b} ) & ∈ {ℝ}^{B \times L \times {D}_{m}}\end{matrix}$$

With respect to the above sequence dimension: W_{id}∈ [symbol] ^{D}^{ₘ}^{×nD}^{ₘ},

$$W \frac{1}{f} - W \frac{1}{b} ∈ {ℝ}_{m}^{D} \times \frac{Dm}{K} ,$$

$$W \frac{2}{f} - W \frac{2}{b} ∈ ℝ \frac{Dm}{K} \times {D}_{m}$$

comprise learnable weight matrices; flip( ) (enabled via flip module 418) de-notes a flipping operation along the sequence dimension; and σ( ) denotes gaussian error linear unit (GELU) activation associated with GELU modules 414a-414d. In this formulation, a dimension of the DSSM may be reduced by a factor of k to speed up kernel computation and combine different dimensions of the DSSM output by using weights

$$W \frac{2}{f} , W \frac{2}{b} .$$

Subsequently, the forward and backward aggregated information may be combined using the following:

$${x}_{cb} = σ ( ( {x}_{f} ⊙ {x}_{b} ) {W}_{cb} ) ∈ {ℝ}^{B \times L \times {nD}_{m}}$$

where W_{cb}∈ [symbol] ^{D}^{ₘ}^{×nD}^{ₘ}. An output of the GDSSM blocks may be computed by combining independently processed information (via pathway 410a) with information from pathways 410b and 410c with a skip connection with respect to an input to a block. Subsequently, a dimension expansion factor of n may be used before using multiplicative gating as follows:

$${x}_{out} = x + ( {x}_{id} ⊙ {x}_{cb} ) {W}_{out} ∈ {ℝ}^{B \times L \times {D}_{m}}$$

With respect to the above multiplicative gating: Wₒᵤₜ∈ [symbol] ^{nD}^{ₘ}^{×D}^{ₘ} is used to bring an output of a multiplicative gate back to a model dimension thereby providing an expressive non-linear bidirectional block to process a sequence of vectors denoted as xₒᵤₜ=BiGDSSM−Block(x).

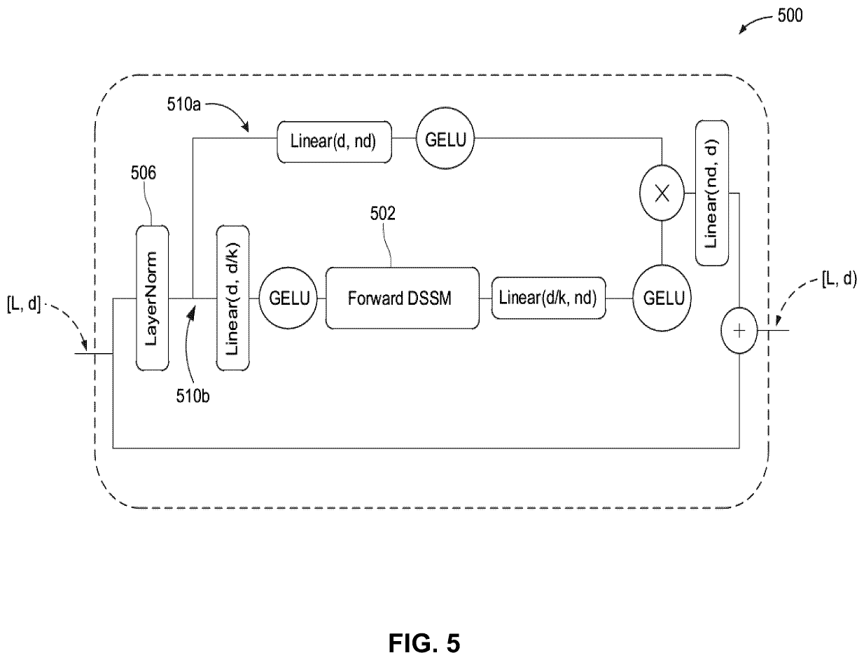

FIG. 5 illustrates unidirectional GDSSM architecture 500, in accordance with some implementations. Unidirectional GDSSM architecture 500 may receive as input: x∈ [symbol] ^{B×L×D}^{ₘ}, such that unidirectional GDSSM blocks (e.g., forward DSSM 502 block) learn to combine information along a sequence dimension L but only in forward direction. As illustrated in FIG. 5, GDSSM architecture 500 comprises an initial layer norm 506 and includes two main pathways 510a and 510b to process information. Pathway 510a is configured to processes information independently. Pathway 510b is configured to processes information with respect to a forward path within a sequence dimension as follows:

$${x}_{N} = LayerNorm ( x ) \qquad ∈ {ℝ}^{B \times L \times {D}_{m}}$$

$${x}_{id} = σ ( {x}_{N} {W}_{id} ) \qquad ∈ {ℝ}^{B \times L \times {nD}_{m}}$$

$${x}_{f} = {DSSM}_{f} ( σ ( {x}_{N} W \frac{1}{f} ) ) W \frac{2}{f} \qquad ∈ {ℝ}^{B \times L \times {D}_{m}}$$

With respect to the above sequence dimension: W_{id}∈ [symbol] ^{D}^{ₘ}^{×nD}^{ₘ},

$$W \frac{1}{f} ∈ {ℝ}_{m}^{D} \times \frac{Dm}{K} , W \frac{2}{f} ∈ ℝ \frac{Dm}{K} \times {D}_{m} .$$

In contrast to bidirectional GDSSM architecture 400 as illustrated with respect to FIG. 4, an output of unidirectional GDSSM architecture 500 is directly computed by combining x_{id} and x_{f} using multiplicative gating and a skip connection with the input to unidirectional GDSSM architecture 500 as follows:

$${x}_{out} = x + ( {x}_{id} ⊙ {x}_{f} ) {W}_{out} ∈ {ℝ}^{B \times L \times {D}_{m}}$$

In the above example, Wₒᵤₜ∈ [symbol] ^{nD}^{ₘ}^{×nD}^{ₘ}. The above causal block is denoted as xₒᵤₜ=UniGDSSM−Block(x).

Subsequently, a spatiotemporal layer may be constructed using GDSSM architecture 400 (as described with respect to FIG. 4) and/or GDSSM architecture 500. For example, an input x∈ [symbol] ^{B×F×J×D}^{ₘ} may be passed through two different information processing streams such that a first stream is configured to combine information spatially and temporally as follows:

xₛ=BiGDSSM−Block1/s(x·flatten(0,1))

xₛ=xₛ·reshape(B,F,J,Dₘ)·T(1,2)

xₜₛ=BiGDSSM−Block1/t(xₛ·flatten(0,1))

xₜₛ=xₜₛ·reshape(B,J,F,Dₘ)·T(1,2)

In the above example, BiGDSSMBlock1/s(⋅) and BiGDSSM−Block1/t(⋅) are the spatial-temporal GDSSM blocks of stream 1 and x·T(a, b) x·flatten(a, b) denote the transpose and flattening of the a-th and b-th dimension of tensor x respectively.

In some implementations, transpose, reshape and flattening operations may be used to process a spatial and temporal dimension using the similar GDSSM Blocks expecting a tensor of shape B×L×Dₘ. In contrast to processing of the first stream, a second stream may be configured to combine information temporally and spatially as follows:

xₜ=BiGDSSM−Blockt2/t(x·T(1,2)·flatten(0,1))

xₜ=xₜ·reshape(B,J,F,Dₘ)

xₛₜ=BiGDSSM−Block2/s(xₜ·T(1,2)·flatten(0,1))

xₛₜ=xₜₛ·reshape(B,F,J,Dₘ)

A final step may include combining outputs of both streams (i.e., the aforementioned first and second streams) using learnable weights given by:

[αₛₜαₜₛ]=softmax([xₛₜxₜₛ] [symbol] )∈ [symbol] ^{B×F×J×2}

xₒᵤₜ=αₛₜ⊙xₛₜ+αₜₛ⊙xₜₛ∈ [symbol] ^{B×F×J×D}ₘ

In the above example, [symbol] ∈ [symbol] ^{B×F×J×D}ₘ is a learnable mapping to the weights which are normalized by using softmax(⋅).

In some implementations, a causal variant of the spatiotemporal model may be designed by replacing temporal blocks in first and second streams with a unidirectional GDSSM block. Therefore, BiGDSSM−Block1/t(.) and BiGDSSM−Block2/t(.) may be replaced with UniGDSSM−Block1/t(.) and UniGDSSM−Block2/t(.).

A pretraining loss architecture 500 (and/or architecture 300 and/or 400 of FIGS. 3 and 4) may be calculated as a combination of 3D and 2D losses as follows:

Initially, a first process to learn a robust motion representation using a universal pretext task is used to recover depth information from 2D visual observations, inspired by a 3D human pose estimation. Large-scale 3D motion capture data may be used to create a 2D-to-3D lifting task such that corrupted 2D skeleton sequences are generated from 2D projections of 3D motion. The skeleton sequences mimic real-world issues such as, inter alia, occlusions and errors. The aforementioned information is used to obtain motion representation and reconstruct 3D motion, with loss functions for 3D reconstruction and velocity.

A second process may utilize heterogeneous human motion data in various formats by extracting 2D skeletons from different motion data sources using in-the-wild RGB videos. For example, the 2D skeletons may be obtained from RGB videos via manual annotation or by using a 2D pose estimator. Additional masking and noise may be applied to degrade the 2D skeletons and since 3D motion ground truth data may not be available for this data, a weighted 2D re-projection loss may be used.

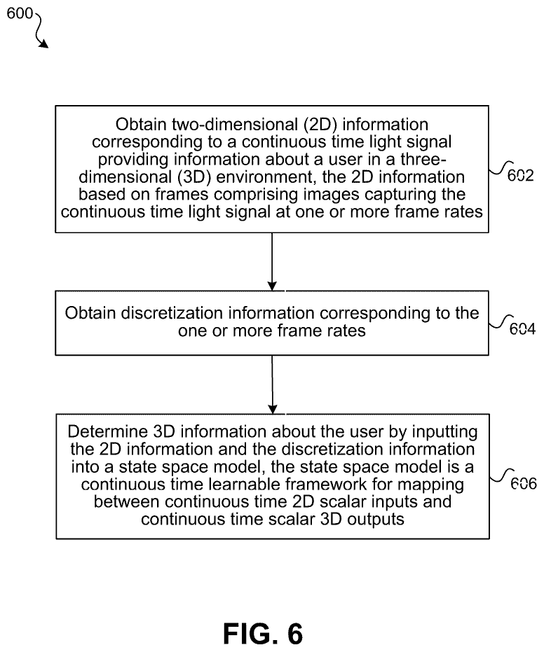

FIG. 6 is a flowchart representation of an exemplary method 600 that determines 3D information associated with a user from a continuous time signal captured by an image sensor at discrete times, in accordance with some implementations. In some implementations, the method 600 is performed by a device, such as a mobile device, desktop, laptop, HMD, or server device. In some implementations, the device has a screen for displaying images and/or a screen for viewing stereoscopic images such as an HMD (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains 2D information corresponding to a continuous time light signal providing information about a user in a 3D environment. The 2D information may be based on video frames comprising images capturing the continuous time light signal at one or more frame rates. For example, a continuous light reflected from a user 102 may be captured by an image sensor at discrete times/frames as described with respect to FIG. 1. In some implementations, the 2D information may include information associated with 2D locations of joints of the user. For example, input that includes 2D joint positions and associated interactions to produce a spatiotemporal representation as described with respect to FIG. 3.

At block 604, the method 600 obtains discretization information corresponding to the one or more frame rates. The discretization information may include delta information (e.g., Δ 202 as described with respect to FIG. 2) corresponding to time periods between the frames. In some implementations, the discretization information comprises information associated with the at least one or more frame rates.

At block 606, the method 600 determines 3D information about the user by inputting the 2D information and the discretization information into a state space model (SSM) such as SSM 200 as described with respect to FIG. 2. The state space model comprises a continuous time learnable framework for mapping between continuous time 2D scalar inputs and continuous time scalar 3D outputs. In some implementations, the 3D information may provide a 3D model or mesh representing at least a portion of the user. In some implementations, the 3D information may provide a 3D representation of at least one joint of the user at a specified location (e.g., joint positions as described with respect to FIG. 3) within the 3D environment. In some implementations, the 3D information may provide information associated with an action performed by the user and a number of times that the action is performed as described with respect to FIG. 1.

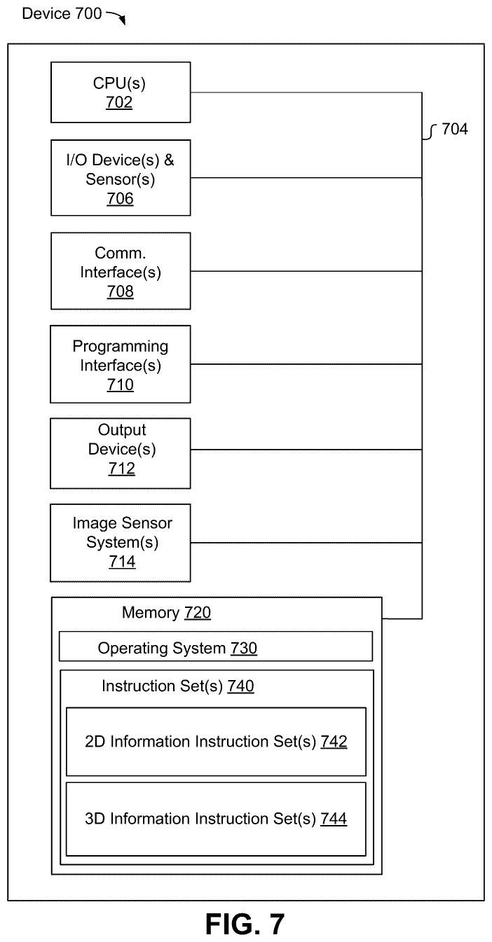

FIG. 7 is a block diagram of an example device 700. Device 700 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 710, output devices (e.g., one or more displays) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 712 are configured to present a view of a physical environment, a graphical environment, an extended reality environment, etc. to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 100. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, sensor data may be obtained by device(s) (e.g., device 105 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes an 2D information instruction set 742 and 3D information instruction set 744. The instruction set(s) 740 may be embodied as a single software executable or multiple software executables.

The 2D information instruction set 742 is configured with instructions executable by a processor to obtain two-dimensional (2D) information (e.g., 2D joint locations) corresponding to a continuous time light signal.

The 3D information instruction set 744 is configured with instructions executable by a processor to determine 3D information about the user by inputting the 2D information and the discretization information into a state space model.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having a processor:
obtaining two-dimensional (2D) information corresponding to a continuous time light signal providing information about a user in a three-dimensional (3D) environment, the 2D information based on frames comprising images capturing the continuous time light signal at one or more frame rates;
obtaining discretization information corresponding to the one or more frame rates; and
determining 3D information about the user by inputting the 2D information and the discretization information into a state space model, the state space model is a continuous time learnable framework for mapping between continuous time 2D scalar inputs and continuous time scalar 3D outputs.

2. The method of claim 1, wherein the discretization information comprises delta information corresponding to time periods between the frames.

3. The method of claim 1, wherein the discretization information comprises information associated with the at least one or more frame rates.

4. The method of claim 1, wherein the 2D information comprises information associated with 2D locations of joints of the user.

5. The method of claim 1, wherein the 3D information provides a 3D model representing at least a portion of the user.

6. The method of claim 1, wherein the 3D information provides a 3D representation of at least one joint of the user at a specified location within the 3D environment.

7. The method of claim 1, wherein the 3D information provides information associated with an action performed by the user.

8. The method of claim 7, wherein 3D information provides information associated with a number of times the action is performed by the user.

9. The method of claim 1, wherein the 3D information comprises information associated with a 3D mesh.

10. The method of claim 1, wherein the continuous time light signal is captured by an image sensor.

11. A non-transitory computer-readable medium comprising instructions that when executed by a processor cause the processor to perform operations comprising:
obtaining two-dimensional (2D) information corresponding to a continuous time light signal providing information about a user in a three-dimensional (3D) environment, the 2D information based on frames comprising images capturing the continuous time light signal at one or more frame rates;
obtaining discretization information corresponding to the one or more frame rates; and
determining 3D information about the user by inputting the 2D information and the discretization information into a state space model, the state space model is a continuous time learnable framework for mapping between continuous time 2D scalar inputs and continuous time scalar 3D outputs.

12. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining two-dimensional (2D) information corresponding to a continuous time light signal providing information about a user in a three-dimensional (3D) environment, the 2D information based on frames comprising images capturing the continuous time light signal at one or more frame rates;
obtaining discretization information corresponding to the one or more frame rates; and
determining 3D information about the user by inputting the 2D information and the discretization information into a state space model, the state space model is a continuous time learnable framework for mapping between continuous time 2D scalar inputs and continuous time scalar 3D outputs.

13. The electronic device of claim 12, wherein the discretization information comprises delta information corresponding to time periods between the frames.

14. The electronic device of claim 12, wherein the discretization information comprises information associated with the at least one or more frame rates.

15. The electronic device of claim 12, wherein the 2D information comprises information associated with 2D locations of joints of the user.

16. The electronic device of claim 12, wherein the 3D information provides a 3D model representing at least a portion of the user.

17. The electronic device of claim 12, wherein the 3D information provides a 3D representation of at least one joint of the user at a specified location within the 3D environment.

18. The electronic device of claim 12, wherein the 3D information provides information associated with an action performed by the user.

19. The electronic device of claim 18, wherein 3D information provides information associated with a number of times the action is performed by the user.

20. The electronic device of claim 12, wherein the 3D information comprises information associated with a 3D mesh.
